(19) United States
(12) Patent Application Publication
(10) Pub. No.: US 2025/0296057 A1
(43) Pub. Date: Sep. 25, 2025

(54) STIRRING DEVICE

(71) Applicant: PRIMIX CORPORATION, Awaji-shi, Hyogo (JP)

(72) Inventor: Takayuki WANI, Hyogo (JP)

(21) Appl. No.: 18/869,579

(22) PCT Filed: May 16, 2023
(86) PCT No.: PCT/JP2023/018272

§ 371 Date: Nov. 26, 2024

(30) Foreign Application Priority Data
May 27, 2022 (JP) 2022-086598
May 27, 2022 (JP) 2022-086599

(51) Int. Cl. B01F 27/1125; B01F 27/81; B01F 27/94

(52) U.S. Cl. CPC B01F 27/11251; B01F 27/81; B01F 27/94

(57) ABSTRACT

A stirring device of thin-film rotation type includes a tubular portion whose lateral surface has: a band-shaped first region extending circumferentially of the tubular portion and including holes penetrating in a inward-outward direction; and a band-shaped second region extending circumferentially of the tubular portion and including no hole or holes penetrating in the inward-outward direction, where the second region has a smaller aperture ratio than the first region. The first region is located to include a middle of the tubular portion in a height direction The second region ranges from the upper edge of the first region to the upper end of the tubular portion and also from the lower edge of the first region to the lower end of the tubular portion. The first region has a width Wp, and the tubular portion has a height H, where 0<Wp<0.5H.

### TECHNICAL FIELD

The present invention relates to stirring devices for use in the emulsifying and dispersing processes to produce slurries containing conductive materials, for example.

### BACKGROUND ART

The demand for batteries, such as lithium-ion secondary batteries and fuel cells, is expected to increase in the future, for use as power sources of portable electronic devices and electric vehicles, as well as for storing power generated by wind and solar power generation facilities. In addition to the need to improve the characteristics of the batteries, such as compactness, lightness, and safety, there is also a need to produce such batteries more efficiently and at lower cost.

As an effective solution to the issues noted above, Patent Document 1 discloses a high-speed stirrer. The high-speed stirrer includes a cylindrical stirring tank, and a rotary shaft disposed in the tank. The rotary shaft is coaxial with the tank and is provided with a rotary blade that is slightly smaller in diameter than the tank. When the blade rotates at high speed, the liquid material to be processed is forced to take the shape of a thin cylindrical film over the inner surface of the tank and stirred. The blade includes a multi-hole cylinder on the outer circumference, and this cylinder is formed with small through holes each extending in the radial direction. This high-speed stirrer with a cylinder having a number of small through holes is simple in structure but capable of efficient stirring. In addition, the stirrer has no surface that collides with liquid material to be processed. This provides advantages in stirring a liquid material containing solid components since abrasion is less likely to occur, thereby reducing the risk of metal fragments of the blade falling into the liquid.

Patent Document 2 discloses a stirring system that utilizes the high-speed stirrer of Patent Document 1. The stirring system enables the efficient production of a coating material for forming battery electrodes that is suitable for improving the battery performance while maintaining the high safety level of the batteries.

### PRIOR-ART DOCUMENT

### Patent Document

Patent Document 1: JP-A-H11-347388
Patent Document 2: WO2010/018771

### SUMMARY OF THE INVENTION

### Problem to be Solved by the Invention

In recent years, linear carbon, such as carbon nanotubes (CNTs), has been used as additives for batteries and resins. In general, linear carbon, such as CNTs, has excellent properties, including a larger specific surface area than that of conventional carbon materials. Thus, using CNTs for lithium-ion secondary batteries as part of the conductive material is expected to improve their performance. However, linear carbon, such as CNTs, has strong cohesion due to the large specific surface area and other factors, making it difficult to obtain slurries that are uniformly mixed and dispersed. The present inventor made a diligent study and found that it is possible to address the above issues by modifying the arrangement of the radially extending through holes in the cylindrical portion (the tubular portion) of the rotary blade (rotating member) and/or by modifying other features.

### Means to Solve the Problem

Specifically, a stirring device according to the present invention includes: a vessel; and a rotating member that rotates at high speed at a location slightly inside an inner wall surface of the vessel. The stirring device stirs a material formed into a thin-film shape between the rotating member and the inner wall surface by centrifugal force of the rotating member. The rotating member includes a tubular portion disposed with a small gap from the inner wall surface of the vessel. The tubular portion includes a lateral surface provided with: a first region having a band shape extending in a circumferential direction of the tubular portion, where the first portion includes a plurality of holes penetrating in an inward-outward direction; and a second region having a band shape extending in a circumferential direction of the tubular portion, where the second region may include a plurality of holes penetrating in the inward-outward direction, where the second region has a smaller aperture ratio than the first region. The first region includes a middle of the tubular portion in a height direction, and the second region ranges from an upper edge of the first region to an upper end of the tubular portion and also from a lower edge of the first region to a lower end of the tubular portion. The first region has a width Wp, and the tubular portion has a total height H, where the relation 0<Wp<0.5H is satisfied.

Preferably, the stirring device is characterized by that P1 denotes the aperture ratio of the first region having the plurality of holes penetrating in the inward-outward direction, and P2 denotes the aperture ratio of the second region having the plurality of holes extending in the inward-outward direction, where the relations 0≤P2/P1<0.5, and P1>0 are satisfied.

Preferably, in the stirring device, each of the plurality of holes penetrating in the inward-outward direction in the first region has a larger opening area on inside than on outside. Preferably, each of the plurality of holes penetrating in the inward-outward direction in the first region has a greater number of openings on inside than on outside. Preferably, each of the plurality of holes penetrating in the inward-outward direction in the first region has a passage that branches within the tubular portion.

Preferably, the rotating member includes a horizontal portion that is perpendicular to a rotation axis of the rotating member, and the horizontal portion is configured to divide an internal space of the tubular portion into an upper space and a lower space.

Preferably, each of the plurality of holes penetrating in the inward-outward direction in the first region has a passage that branches within the tubular portion, and each of the plurality of holes has an inside opening in the upper space and another inside opening in the lower space. Preferably, a plurality of holes penetrating in the inward-outward direction in the first region include: first holes each having an inside opening in the upper space; and second holes each having an inside opening in the lower space, where the first and second holes are arranged alternately in the circumferential direction of the tubular portion.

Advantages of the Invention

In general, a stirring device (a stirring device of a thin-film rotation type) including a vessel and a rotating member that rotates at high speed at a location slightly inside an inner wall surface of the vessel stirs a material while forcing the material by centrifugal force of the rotating member into a thin-film shape between the rotating member and the inner wall surface. The material is fed into the vessel from an inlet disposed at the bottom of the vessel and is rotated at high speed by being pulled by the inner and outer peripheral surfaces of a tubular portion of the rotating member. By the action of the centrifugal force generated by the rotation of the rotating member, the material being rotated in the tubular portion of the rotating member flows through a plurality of holes that penetrate the tubular portion of the rotating member in the inward-outward direction to be fed into the space between the vessel and the rotating member (clearance section). The material fed into the clearance section is urged against the inner surface of the vessel to take the shape of a thin film and rotated. Consequently, the material, which is fed to the space between the vessel and the rotating member and forced into the shape of thin film, is rotated at a different rotational speed between the area near the surface of the rotating member and the area near the inner surface of the vessel. The difference in the rotational speeds generates shear force, which contributes to mixing of the material.

Note here that the tubular portion of the rotating member is configured as described above and has the lateral surface that includes: the first region having a band shape extending in the circumferential direction of the tubular portion and including the plurality of holes penetrating in the inward-outward direction; and the second region having a band shape extending in the circumferential direction of the tubular portion and including the plurality of holes penetrating in the inward-outward direction, such that the second region has a smaller aperture ratio than the first region. The first region includes the middle of the tubular portion in the height direction, and the second region ranges from the upper edge of the first region to the upper end of the tubular portion and also from the lower edge of the first region to the lower end of the tubular portion. When Wp denotes the width of the first region, and H denotes the total height of the tubular portion, the relation given by 0<Wp<0.5H is satisfied. With this configuration, when the centrifugal force is applied by the rotating member, the material inside the tubular portion of the rotating member is fed into the clearance section by intensively flowing through the plurality of holes penetrating in the inward-outward direction in the first region, which includes the middle of the tubular portion in the height direction. Consequently, the pressure of the material in the clearance section is higher at the area opposite the first region of the tubular portion of the rotating member than at the area opposite the second region. This accelerates the material flow, moving the material near the middle of the tubular portion in the height direction toward the upper and lower ends of the tubular portion, while the material is being rotated. In this way, the circulation of the material between the inside of the tubular portion of the rotating member and the clearance section is accelerated, improving the processing efficiency of the material. It is noted that the material in the clearance section is rotated at a different speed between the area near the outer surface of the rotating member and the area near the inner surface of the vessel, so that high friction occurs between the material and each of the inner surface of the vessel and the rotating member, resulting in the generation of high heat. However, by accelerating the circulation of the material between the inside of the tubular portion of the rotating member and the clearance section as described above, the temperature rise of the material is reduced because the material passes the clearance section within a shorter period time.

Generally, for a stirring device of a thin-film rotation type, the aperture ratio of a plurality of holes formed in the tubular portion of the rotating member to penetrate in the inward-outward direction affects the shear force that acts on the material and also affects the speed at which the material flows from the inside of the tubular portion into the clearance section. Specifically, the shear force that acts on the material is larger when the aperture ratio of the holes in the tubular portion is smaller and thus contact area between the tubular portion and the material is larger, whereas the shear force is smaller when the aperture ratio is larger and thus the contact area is smaller. On the other hand, the speed at which the material is fed from the inside of the tubular portion of the rotating member into the clearance section is lower when the aperture ratio of the holes formed in the tubular portion is smaller, whereas the speed is higher when the aperture ratio is larger. As described above, there is a trade-off between the shear force acting on the material and the speed at which the material is fed from the inside of the tubular portion of the rotating member into the clearance section.

As described above, when P1 denotes the aperture ratio of the first region, and P2 denotes the aperture ratio of the second region, the provision of the second region satisfying the relation given by 0≤P2/P1<0.5 and P1>0 ensures that a large shear force is be applied to the material present at a location opposite the second region in the clearance section and thus ensures sufficient stirring. On the other hand, the second region has a smaller aperture ratio and thus reduces the speed at which the material flows from the inside of the tubular portion of the rotating member into the clearance section. However, the influence is compensated for as follows. That is, the pressure of the material in the clearance section is higher at the area opposite the first region of the tubular portion of the rotating member than at the area opposite the second region. This accelerates the material flow, moving the material near the middle of the tubular portion in the height direction toward the upper and lower ends of the tubular portion, while the material is being rotated. In other words, since the material flows from the inside of the tubular portion into the clearance section intensively through the holes in the first region, which includes the middle of the tubular portion in the height direction, and subsequently flows toward the upper and lower ends of the tubular portion, a sufficient amount of material is fed to the area of the clearance section that is opposite the second region.

Further, in the stirring device according to the present invention, the tubular portion of the rotating member includes a plurality of holes penetrating in the inward-outward direction in the first region, and the opening area of each hole on inside is larger than the opening area of the hole on the outside. With this configuration, the flow of the material from the inside of the tubular portion of the rotating member into the clearance section is accelerated, increasing the pressure of the material in the clearance section at the area opposite the first region of the tubular portion. This subsequently accelerates the material flow, moving the material near the middle of the tubular portion in the height direction toward the upper and lower ends of the tubular portion, the material while is being rotated. Consequently, the circulation of the material between the inside of the tubular portion of the rotating member and the clearance section is further accelerated. This further improves the processing efficiency of the material, the effect of reducing the temperature rise of the material, and the effect of achieving sufficient stirring by applying a large shear force to the material.

As noted above, the opening area of the plurality of holes that penetrate in the inward-outward direction in the first region of the tubular portion is larger on the inside than on the outside, and such holes are formed as follows. Preferably, each hole has a greater number of openings on the inside than on the outside, and specifically, it is preferable that each hole has a passage that branches within the tubular portion of the rotating member.

Further, in the stirring device according to the present invention, the rotating member preferably includes a horizontal portion that is perpendicular to a rotation axis of the rotating member, the horizontal portion dividing an internal space of the tubular portion into an upper space and a lower space. With the internal space of the tubular portion divided into the upper space and the lower space by the horizontal portion as described above, the circulation of the material is caused more reliably between the inside of the tubular portion of the rotating member and the clearance section. This makes it possible to more reliably achieve the effect of improving the processing efficiency of the material, the effect of reducing the temperature rise of the material, and the effect of achieving sufficient stirring by applying a large shear force to the material.

In this case, the plurality of holes penetrating in the inward-outward direction in the first region have either of the following configurations:
(1) Individual holes have a passage that branches within the tubular portion into two inside openings, one of which is located in the upper space and the other in the lower space; or
(2) Holes having an inside opening in the upper space and holes having an inside opening in the lower space are alternately arranged in the circumferential direction of the tubular portion. Either configuration allows the material in the upper space and the material in the lower space to be mixed when the material is forced to flow into the clearance section intensively through the holes in the first region. This ensures that the circulation of the material takes place in a manner that the material in the upper space and the material in the lower space are appropriately exchanged, rather than that the circulation of the material between the tubular portion of the rotating member and the clearance section takes place separately in the upper space and the lower space. This makes it possible to more reliably achieve the effect of improving the processing efficiency of the material, the effect of reducing the temperature rise of the material, and the effect of achieving sufficient stirring by applying a large shear force to the material.

Other features and advantages of the present invention will be more apparent from the detailed description given below with reference to the attached drawings.

### BRIEF DESCRIPTION OF THE DRAWINGS

FIG. 1 is a diagram showing a stirring device according to the present invention.

FIG. 2 is a sectional view of the stirring device according to the present invention.

FIG. 3 is a diagram of a rotating member according to Example 1 of the present invention.

FIG. 4 is a schematic view showing the flow of a material being stirred by the rotating member of Example 1 of the present invention.

FIG. 5 is a diagram of a rotating member according to Example 2 of the present invention.

FIG. 6 is sectional view of the rotating member according to Example 2 of the present invention.

FIG. 7 is a diagram of a rotating member according to Example 3 of the present invention.

FIG. 8 is sectional view of the rotating member according to Example 3 of the present invention.

FIG. 9 is a diagram of a rotating member according to Example 4 of the present invention.

FIG. 10 is a sectional view of the rotating member according to Example 4 of the present invention.

FIG. 11 is a diagram of a rotating member according to a comparative example.

FIG. 12 is a schematic view showing the flow of a material being stirred by the rotating member of the comparative example.

### MODE FOR CARRYING OUT THE INVENTION

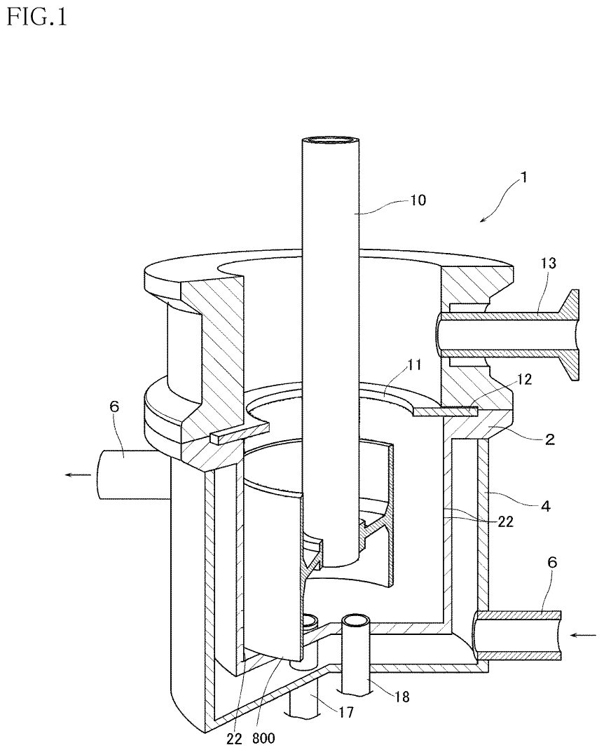

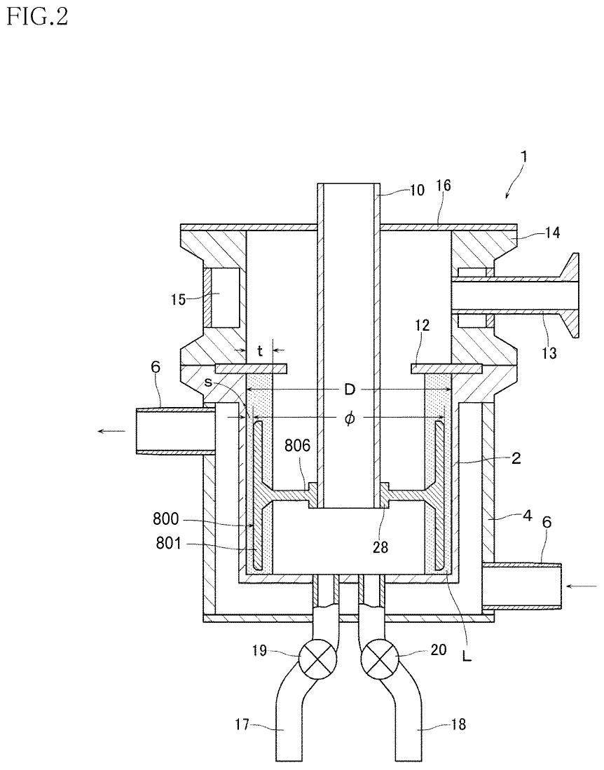

The following describes preferred embodiments of the present invention with reference to the drawings. As shown in FIGS. 1 and 2, a stirring device 1 includes: a cylindrical vessel 2; a jacket 4 connected to a coolant pipe 6 through which coolant is supplied to and discharged from the outer peripheral surfaces of the vessel 2, including the bottom surface; a rotating member 800 (810, 820, 830) disposed with a small gap s from the inner surface 22 of the vessel 2 and rotatable at high speed coaxially with the vessel 2; a shaft 10 supporting the rotating member 800 on its end and driven to rotate in the forward and reverse directions at high speed; an upper vessel 14 disposed above the vessel 2 via a weir plate 12 and having an outlet pipe 13 for discharging a product; and a lid 16 that hermetically seals the upper vessel 14. Inlet pipes 17 and 18 for supplying materials are connected to the bottom of the vessel 2 via valves 19 and 20. For convenience, FIGS. 1 and 2 omit some details, including the lid, the valves, and a plurality of holes penetrating the tubular portion (described later) of the rotating member 800 in the inward-outward direction. As shown in FIG. 2, when the inner diameter of the vessel 2 is denoted by D and the outer diameter of the tubular portion is denoted by φ, these diameters and the gap s described above satisfy the relation s=(D−φ)/2.

As shown in FIG. 2, the upper vessel 14 is provided with a coolant chamber 15 extending along the peripheral surface of the upper vessel 14 through which coolant flows. The weir plate 12 has an opening 11 for allowing the liquid material to be processed (the material to be stirred) to be discharged through the outlet pipe 13.

The rotating member 800 is driven at a high peripheral speed of 10 to 50 m/sec. The stirring device 1 may be enabled to operate under vacuum conditions by hermetically sealing the vessel 2, the upper vessel 14, the lid 16, and the shaft 10 with gaskets and connecting a vacuum evacuation device via a valve.

Next, the following describes operations of a high-speed stirring device according to the present embodiment. With reference to FIG. 2, the weir plate 12 is placed to lid the vessel 2, thereby setting required conditions for the liquid material to be processed. Subsequently, a predetermined amount of liquid material L to be processed is introduced into the vessel 2 from the inlet pipes 17 and 18. Subsequently, the shaft 10, which is connected to a motor not shown in the figures, is driven to rotate at high speed and consequently to rotate the rotating member 800 at high speed.

The rotation speed of the rotating member 800 may be high enough to cause the liquid material L to move in a circumferential direction and to subsequently rotate. Also, by the centrifugal force generated by the rotation, the liquid material L may be forced to take the shape of a rotating thin cylindrical film having a thickness t on the inner surface of the vessel 2. After being stirred, the liquid material L continuously flows over the weir plate 12 into the upper vessel 14, and is discharged to the outside of the vessel 2 through the outlet pipe 13.

Next, the following describes the details of rotating members for use in the stirring device of the present invention and a rotating member for use in a stirring device of a comparative example.

### Example 1

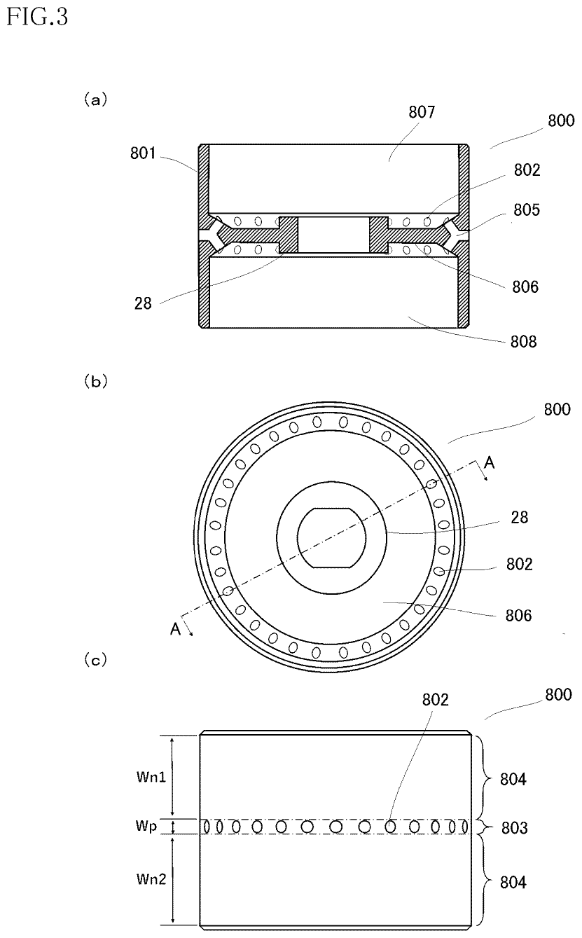

FIG. 3 shows a rotating member 800 of Example 1. FIG. 3(a) is a sectional view of the rotating member 800, taken along line A-A in FIG. 3(b). FIG. 3(b) is a top view of the rotating member 800. FIG. 3(c) is a side view of the rotating member 800. As shown in FIG. 3, the rotating member 800 includes a tubular portion 801. The tubular portion 801 has a lateral surface that is divided, as indicated by the dot-dash lines in FIG. 3(c), into a plurality of band-shaped regions in the circumferential direction. The band-shaped regions include a first region 803 having a plurality of holes 802 penetrating the tubular portion 801 in the inward-outward direction. The first region 803 includes the middle of the tubular portion 801 in the height direction. The upper edge of the first region 803 is defined by an upper line tangent to the opening edges of the holes 802 (the upper dot-dash line in FIG. 3(c)) that are aligned on the lateral surface of the tubular portion 801, and the lower edge of the first region 803 is defined by a lower line tangent to the opening edges of the holes 802 (the lower dot-dash line in FIG. 3(c)). The width Wp of the first region 803 is defined by the distance between the upper and lower tangent lines to the edges of the holes 802. In the first region 803, the spacing between adjacent holes 802 is uniform, and the intervals at which the holes 802 are aligned in the row are also uniform. In Example 1, the holes 802 in the first region 803 are aligned in a single row, but the holes 802 may be aligned in two or more rows as necessary. In this case, the upper edge of the first region 803 is defined by an upper line tangent to the opening edges of the holes 802 in the uppermost row, and the lower edge of the first region 803 is defined by a lower line tangent to the opening edges of the holes 802 in the bottommost row.

As shown in FIG. 3(c), the lateral surface of the tubular portion 801 also includes a second region 804 ranging from the upper edge (the upper tangent line) of the first region 803 to the upper end of the tubular portion 801 and also ranging from the lower edge (the lower tangent line) of the first region 803 to the lower end of the tubular portion 801. The second region 804 may be formed with a required number of holes 802 penetrating in the inward-outward direction, provided that the aperture ratio of the second region 804 is smaller than that of the first region 803. By the example shown in FIG. 3, the second region 804 has no holes (the aperture ratio =0), but this is a non-limiting example. The aperture ratio P is calculated as follows:

P=S1/S2,

where S1 denotes the total opening area of the holes in the target region (the first region or the second region), and

S2 denotes the total area of the target region (the first region or the second region).

In this example, the upper part and the lower part of the second region 804 have the same aperture ratio P. Alternatively, the upper part and the second part may have different aperture ratios P as necessary.

The width Wn of the second region 804 is the sum of the width Wn1, which is the distance between the upper edge of the first region 803 (the upper tangent line to the holes 802) and the upper end of the tubular portion 801, and the width Wn2, which is the distance between the lower edge of the first region 803 (the lower tangent line to the holes 802) and the lower end of the tubular portion 801 (Wn=Wn1+Wn2). The total height H of the rotating member is defined by the height of the lateral surface of the tubular portion 801 and satisfies the relation H=Wp+Wn.

The width Wp of the first region satisfies the relation 0<Wp<0.5H. Note that the widths Wn1 and Wn2 of the upper and lower parts of the second region 804 are equal to each other in this example, but the widths may have different as necessary.

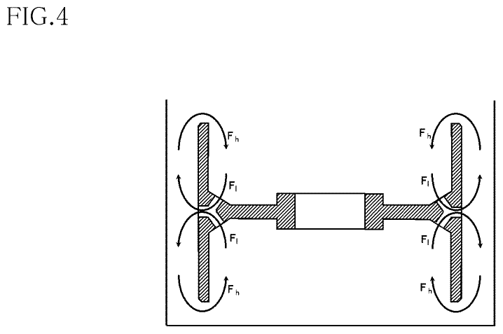

With the rotating member 800 having the structure described above, when the rotating member 800 applies the centrifugal force to the material to be stirred, the material is urged to move from the inside of the tubular portion 801 of the rotating member 800 into the clearance section (see paragraph [0012]). In this process, the material flows more intensively through the holes 802 in the first region 803, which includes the middle part of the tubular portion 801 in the height direction, than through other holes differently located in the tubular portion 801 of the rotating member 800. Consequently, the pressure of the material in the clearance section becomes higher at the area opposite the first region 803 of the tubular portion 801 than at the area opposite the second region 804. This creates the flow of material as shown in FIG. 4, moving the material near the middle of the tubular portion 801 in the height direction toward the upper and lower ends of the tubular portion 801, while the material is being rotated. In this way, the circulation of the material between the inside of the rotating member 800 and the clearance section shown in FIG. 4 is accelerated, improving the processing efficiency of the material.

In general, the rotation speed of the material in the clearance section tends to differ between the side closer to the rotating member 800 and the side closer to the inner surface of the vessel 2. Thus, high friction would occur between the material and the rotating member 800 and between the material and the inner surface of the vessel 2, leading to the generation of high heat. In view of this, the above-described acceleration of circulation of the material between the inside of the tubular portion 801 of the rotating member 800 and the clearance section is effective for reducing the temperature rise of the material, since the material to be stirred is in the clearance section for a shorter period of time, and also the flow of material as shown in FIG. 4 facilitates the exchange of a higher temperature portion Fh and a lower temperature portion Fl.

To enhance the effect of improving the processing efficiency and the effect of reducing the temperature rise, the width Wp of the first region preferably satisfies the relation 0<Wp<0.3H, more preferably 0<Wp<0.2H, and still more preferably 0<Wp<0.1H. On the other hand, the width Wp of the first region should not be too narrow in order not to limit the flow of the material to the clearance section through the holes 802 in the first region 803. In view of this, the width Wp of the first region preferably satisfies the relation Wp>0.01H, more preferably Wp>0.02H, and still more preferably Wp>0.03H.

In addition, generally, for a stirring device of a thin-film rotation type, the aperture ratio P of the holes 802 formed in the tubular portion 801 affects the shear force acting on the material to be stirred, while also affecting the feeding speed of the material from the inside of the rotating member into the clearance section. Specifically, the shear force that acts on the material is larger when the aperture ratio P of the holes 802 formed in the tubular portion 801 is smaller and thus the contact area between the tubular portion 801 and the material is larger. In contrast, the shear force is smaller when aperture ratio P is larger and thus the contact area between the tubular portion 801 and the material is smaller. On the other hand, the speed at which the material is fed from the inside of the tubular portion 801 of the rotating member 800 into the clearance section is lower when the aperture ratio P of the holes 802 formed in the tubular portion 801 is smaller. In contrast, the feeding speed of the material is higher when the aperture ratio P is larger. As described above, there is a trade-off between the shear force acting on the material and the feeding speed of the material from the inside of the tubular portion 801 of the rotating member 800 into the clearance section. In view of this, when P1 denotes the aperture ratio of the holes 802 in the first region 803, and P2 denotes the aperture ratio of the holes 802 in the second region 804, this example is designed to satisfy the relation 0≤P2/P1 <0.5 and P1>0. Providing the second region 804 with a smaller aperture ratio ensures that a large shear force is applied to the material present at a location opposite the second region 804 in the clearance section, ensuring sufficient stirring.

As noted above, the second region 804 having a smaller aperture ratio of holes 802 leads to a lower feeding speed of the material from the inside of the tubular portion 801 of the rotating member 800 into the clearance section, but its influence is compensated for as follows. As described above, the pressure of material in the clearance section is higher at the area opposite the first region 803 of the tubular portion 801 than at the area opposite the second region 804. This creates the flow of material as shown in FIG. 4, moving the material near the middle of the tubular portion 801 in the height direction toward the upper and lower ends of the tubular portion 801, while the material is being rotated. In other words, due to the intensive feeding of material from the inside of the tubular portion 801 to the clearance section through the holes 802 in the first region 803, which includes the middle of the tubular portion 801 in the height direction, and further to the subsequent flow of material toward the upper and lower ends of the tubular portion 801, the material is sufficiently fed to the portion of the clearance that is opposite the second region 804.

In the rotating member 800 of this example, each of a plurality of holes 802 penetrating in the inward-outward direction in the first region 803 of the tubular portion 801 is formed such that the opening area on the inside is larger than the opening area on the outside (see FIG. 3(a)). This accelerates the flow of material from the inside of the tubular portion 801 of the rotating member 800 into the clearance section and further increases the pressure of the material in the clearance section at the area opposite the first region 803 of the tubular portion 801. This accelerates the flow of material, moving the material near the middle of the tubular portion 801 in the height direction toward the upper and lower ends of the tubular portion 801, while the material is being rotated. Consequently, the circulation of the material between the inside of the tubular portion 801 of the rotating member 800 and the clearance section is further accelerated, further improving the processing efficiency of the material, the effect of reducing the temperature rise of the material, and the effect of achieving sufficient stirring by applying a large shear force to the material. In order to improve the effects of the present invention described above, the aperture ratios of the holes 802 in the first region 803 and the second region 804 preferably satisfy the relation 0≤P2/P1<0.25 and P1>0, more preferably 0≤P2/P1<0.1 and P1>0, and still more preferably 0≤P2/P1<0.05 and P1>0.

As described above, the rotating member 800 has a plurality of holes 802 penetrating in the inward-outward direction in the first region 803, and the opening area of each hole 802 is larger on the inside than on the outside. In this example, this is achieved by each hole having a larger number of openings on the inside than on the outside. More specifically, each hole 802 has a passage 805 that branches within the tubular portion 801 to connect one outside opening to two inside openings.

In addition, the rotating member 800 of this example includes a horizontal portion 806 in the tubular portion 801. The horizontal portion 806 is perpendicular to the rotation axis of the rotating member 800, dividing the internal space of the tubular portion 801 into the upper space 807 and the lower space 808. With the internal space of the tubular portion 801 divided into the upper and lower spaces by the horizontal portion 806 as described above, the circulation of the material is caused more reliably between the inside of the tubular portion 801 of the rotating member 800 and the clearance section. This makes it possible to more reliably achieve the effect of improving the processing efficiency of the material, the effect of reducing the temperature rise of the material, and the effect of achieving sufficient stirring by applying a large shear force to the material. Preferably, the horizontal portion 806 isolates the upper space 807 and the lower space 808 in a manner to prohibit the passage of the material between the upper space 807 and the lower space 808 via the horizontal portion 806. In the example shown in the figures, the horizontal portion 806 includes a boss 28 that is in contact with the shaft 10.

In this example, each hole 802 in the first region 803 penetrating in the inward-outward direction has two openings on the inside: one in the upper space 807 and the other in the lower space 808. The two inside openings are connected to one outside opening by the passage 805 extending through the tubular portion 801. This allows the material in the upper space and the material in the lower space to be mixed when they are forced to flow into the clearance section through the holes in the first region. This prevents the circulation of the material between the tubular portion 801 of the rotating member 800 and the clearance section from occurring separately for the upper space 807 and the lower space 808. Instead, the circulation of the material takes place in a manner that the material in the upper space 807 and the material in the lower space 808 are appropriately exchanged. This makes it possible to more reliably achieve the effect of improving the processing efficiency of the material, the effect of reducing the temperature rise of the material, and the effect of achieving sufficient stirring by applying a large shear force to the material.

### Example 2

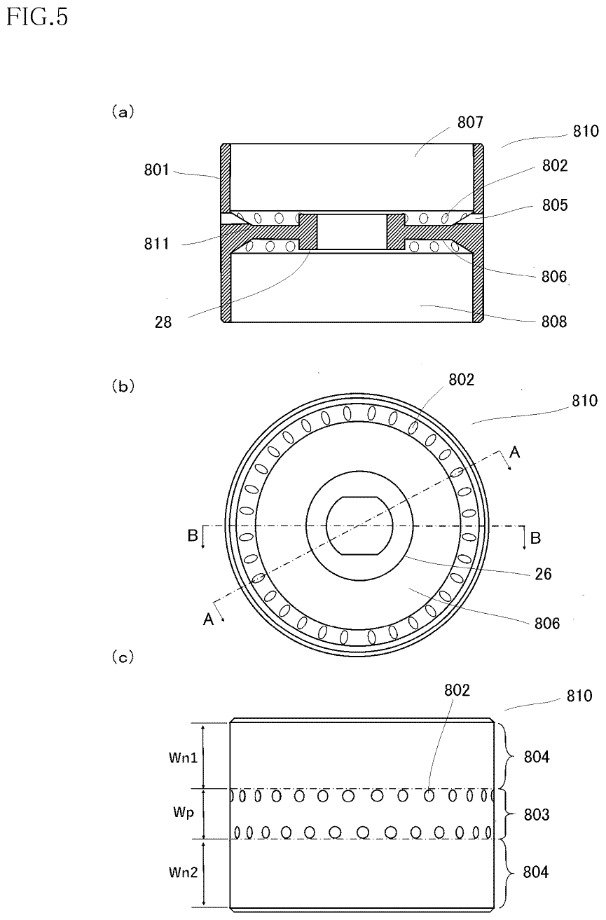

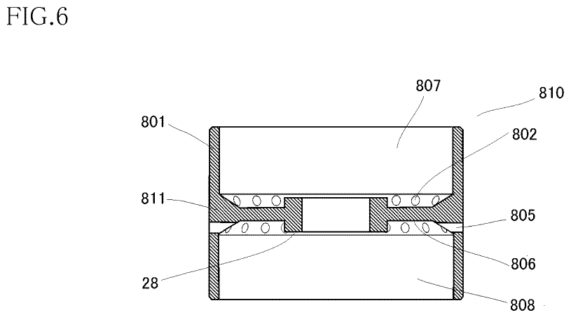

FIG. 5 shows a rotating member 810 according to Example 2. FIG. 5(a) is a sectional view of the rotating member 810, taken along line A-A in FIG. 5(b). FIG. 5(b) is a top view of the rotating member 810. FIG. 5(c) is a side view of the rotating member 810. FIG. 6 is a sectional view of the rotating member 810, taken along line B-B in FIG. 5(b).

The rotating member 810 is similar to the rotating member 800 of Example 1, except for the structure and arrangement of a plurality of holes 802 penetrating in the inward-outward direction in the first region 803. Specifically, although the rotating member 810 has a plurality of inside openings in both the upper space 807 and the lower space 808, each hole 802 has one inside opening and one outside opening. In other words, the passage 805 of each hole 802 extending through the tubular portion 801 does not connect two or more inside openings to one outside opening, rather it connects one inside opening and one outside opening. In addition, the inside opening of each hole 802 is located on an inclined section 811 of the tubular portion 801 and thus is diagonally angled. Consequently, each hole 802 has a larger opening area on the inside than on the outside. In addition, the plurality of holes 802 penetrating in the inward-outward direction are arranged such that their openings are aligned in rows, such that the openings in the upper space 807 and the lower space 808 alternate in the circumferential direction of the tubular portion 801 as shown in FIG. 5(c). This configuration makes it possible to more reliably achieve the effect of improving the processing efficiency of the material, the effect of reducing the temperature rise of the material, and the effect of achieving sufficient stirring by applying a large shear force to the material.

### Example 3

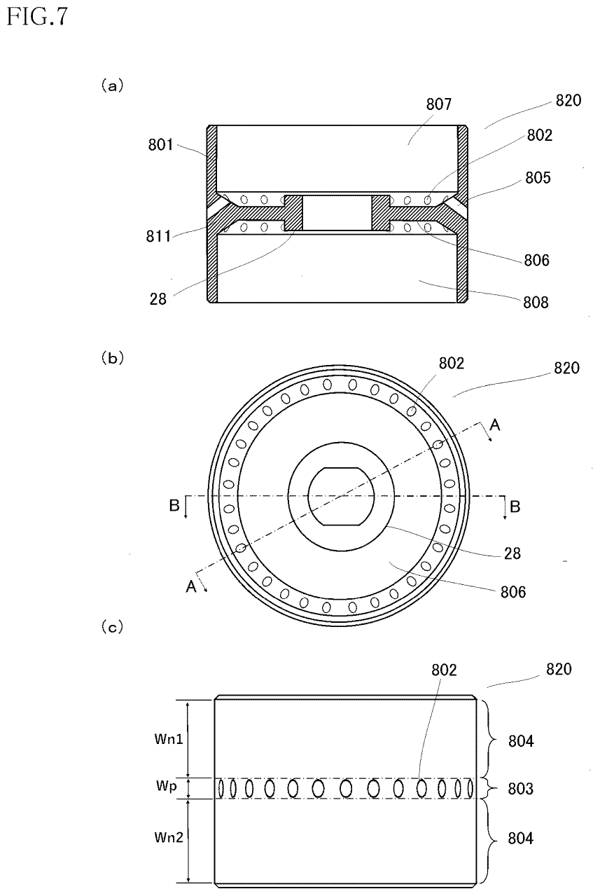

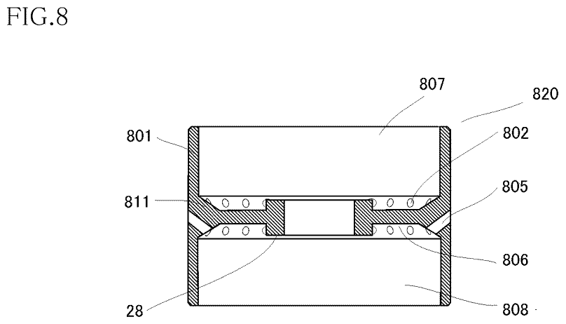

FIG. 7 shows a rotating member 820 according to Example 3. FIG. 7(a) is a sectional view of the rotating member 820, taken along line A-A in FIG. 7(b). FIG. 7(b) is a top view of the rotating member 820. FIG. 7(c) is a side view of the rotating member 820. FIG. 8 is a sectional view of the rotating member 820, taken along line B-B in FIG. 7(b).

The rotating member 820 is similar to the rotating member 810 of Example 2, except for the structure and arrangement of a plurality of holes 802 penetrating in the inward-outward direction in the first region 803. Specifically, the passage 805 of each hole 802 connecting its inside opening and outside opening extends obliquely in the tubular portion 801. As shown in FIG. 7(c), the plurality of holes 802 penetrating in the inward-outward direction are arranged such that the openings of the holes in the upper space 807 and the openings of the holes in the lower space 808 are alternately aligned in a single row in the circumferential direction of the tubular portion 801. This configuration makes it possible to more reliably achieve the effect of improving the processing efficiency of the material, the effect of reducing the temperature rise of the material, and the effect of achieving sufficient stirring by applying a large shear force to the material.

### Example 4

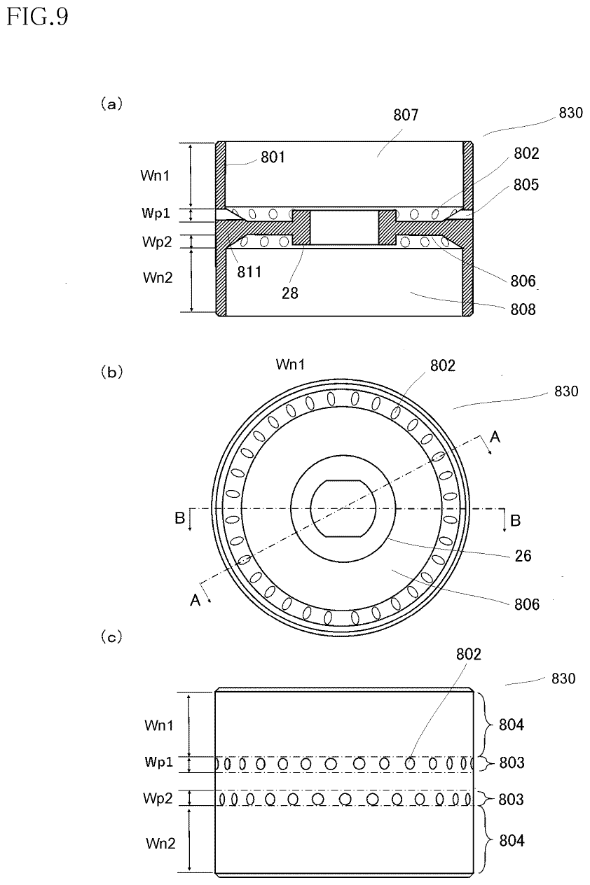

FIG. 9 shows a rotating member 830 according to Example 4. FIG. 9(a) is a sectional view of the rotating member 830, taken along line A-A in FIG. 9(b). FIG. 9(b) is a top view of the rotating member 830. FIG. 9(c) is a side view of the rotating member 830. A stirring device of Example 4 includes a vessel, and a rotating member that rotates at high speed at a location slightly inside an inner wall surface of the vessel. The stirring device stirs a material while forcing the material by centrifugal force of the rotating member into a thin-film shape between the rotating member and the inner wall surface. The rotating member includes a tubular portion positioned with a small gap from the inner wall surface of the vessel, and a horizontal portion perpendicular to a rotation axis of the rotating member, where the horizontal portion is disposed within the tubular portion and divides an internal space of the tubular portion into an upper space and a lower space. The tubular portion has a lateral surface surrounding the upper space and a lateral surface surrounding the lower space. Each lateral surface includes: a first region having a band shape extending in a circumferential direction of the tubular portion and including a plurality of holes penetrating in an inward-outward direction of the tubular portion; and a second region having a band shape extending in a circumferential direction of the tubular portion and including no or a plurality of holes penetrating in the inward-outward direction, where the second region has a smaller aperture ratio than the first region. The first region is located in the lateral surface surrounding the upper space and in the lateral surface surrounding the lower space, while also being positioned closer to the horizontal portion. The second region ranges from the upper edge of the first region that is located in the lateral surface surrounding the upper space to the upper end of the tubular portion, and also ranges from the lower edge of the first region that is located in the lateral surface of the tubular portion surrounding the lower space to the lower end of the tubular portion. A plurality of holes formed in the first region is aligned in three or fewer rows in the circumferential direction of the tubular portion.

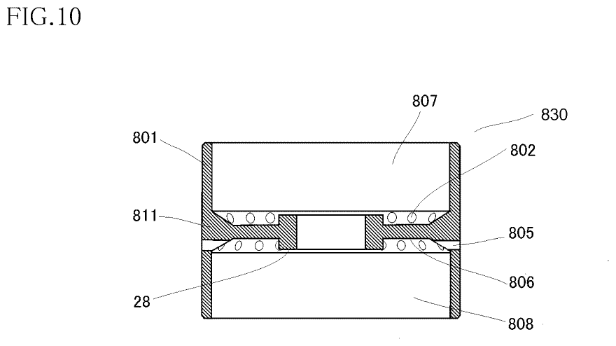

FIG. 10 is a sectional view of the rotating member 830, taken along line B-B in FIG. 9(b). As shown in FIG. 9, the rotating member 830 includes the horizontal portion 806 in the tubular portion 801. The horizontal portion 806 is perpendicular to the rotation axis of the rotating member 830, dividing the internal space of the tubular portion 801 into the upper space 807 and the lower space 808. As indicated by the dot-dash lines in FIG. 9(c), the tubular portion 801 of the rotating member 830 includes the first region 803 having a band shape extending in a circumferential direction of the tubular portion and including a plurality of holes 802 penetrating in the inward-outward direction of the tubular portion 801. The first region 803 is located in the lateral surface surrounding the upper space and also in the lateral surface surrounding the lower space, while also being positioned closer to the horizontal portion (the middle of the tubular portion 801 in the height direction).

The first region 803 in the lateral surface surrounding the upper space 807 of the tubular portion 801 has an upper edge that is defined by the upper one of the tangent lines (the upper dot-dash line in FIG. 9(c)), which are tangent to the opening edges of the holes 802 that are aligned on the lateral surface of the tubular portion 801, and has a lower edge that is defined by the height of the surface of the horizontal portion 806 facing the upper space 807 (the lower dot-dash line in FIG. 9(c)). The width Wp1 of the first region 803 in the lateral surface surrounding the upper space 807 of the tubular portion 801 is defined by the distance between the upper tangent line and the height of the surface of the horizontal portion 806 facing the upper space 807. In the first region 803, the spacing between adjacent holes 802 is uniform, and the spacing between the rows of the holes 802 is also uniform.

The first region 803 in the lateral surface surrounding the lower space 808 of the tubular portion 801 has an lower edge that is defined by the lower one of the tangent lines (the lower dot-dash line in FIG. 9(c)), which are tangent to the opening edges of the holes 802 that are aligned on the lateral surface of the tubular portion 801, and has a upper edge that is defined by the height of the surface of the horizontal portion 806 facing the lower space 808 (the upper dot-dash line in FIG. 9(c)). The width Wp2 of the first region 803 in the lateral surface surrounding the lower space 808 of the tubular portion 801 is defined by the distance between the upper tangent line which is tangent to the opening edges of the holes 802, and the height of the surface of the horizontal portion 806 facing the upper space 807. In the first region 803, the spacing between the holes 802 is uniform, and the spacing between the rows of the holes 802 is also uniform.

In this example, the widths Wp1 and Wp2 of the first region 803 in the lateral surfaces of the tubular portion 801 surrounding the upper space 807 and the lower space 808 are the same. However, the widths Wp1 and Wp2 may be different as necessary. In this example, the holes 802 in each first region 803 are aligned in a single row, but the holes 802 may be aligned in two or more rows as necessary. In this case, the upper edge of the first region 803 is defined by a line tangent to the upper opening edges of the holes 802 in the uppermost row, and the lower edge of the first region 803 is defined by a line tangent to the lower opening edges of the holes 802 in the bottommost row.

As shown in FIG. 9(c), the lateral surface of the tubular portion 801 includes the second region 804 ranging from the upper edge of the first region 803 in the lateral surface surrounding the upper space 807 to the upper end of the tubular portion 801, and also from the lower edge of the first region 803 in the lateral surface surrounding the lower space 808 to the lower end of the tubular portion 801. The second region 804 may have any number of holes 802 penetrating in the inward-outward direction, provided that the aperture ratio of the second region 804 is smaller than that of the first region 803. In FIG. 9, the second region 804 has no holes (the aperture ratio=0), but this is a non-limiting example. The aperture ratio P is calculated as follows:

P=S1/S2,

where S1 denotes the total opening area of the holes of in the target region (a first region or a second region), and

S2 denotes the total area of the target region (a first region or a second region).

In this example, the first region 803 in the lateral surface of the tubular portion 801 that surrounds the upper space 807 and the first region 803 in the lateral surface of the tubular portion 801 that surrounds the lower space 808 have the same aperture ratio P. Similarly, the second region 804 in the lateral surface of the tubular portion 801 that surrounds the upper space 807 and the second region 804 in the lateral surface of the tubular portion 801 that surrounds the lower space 808 have the same aperture ratio P. However, they may have different aperture ratios P as necessary.

The width of the second region 804 is defined by the widths Wn1 and Wn1. The width Wn1 is defined by the distance between the upper edge of the first region 803 that is located in the lateral surface surrounding the upper space (the upper tangent line to the opening edges of the holes 802 in the uppermost row) and the upper end of the tubular portion 801. The width Wn2 is defined by the distance between the lower edge of the first region 803 that is located in the lateral surface surrounding the lower space (the lower tangent line to the opening edges of the holes 802 in the bottommost row) and the lower end of the tubular portion 801. In this example, the widths Wn1 and Wn2 of the second region 804 in the lateral surface surrounding the upper space and the lower space are the same. However, the widths Wn1 and Wn2 may be different as necessary. In this example, in addition, the holes 802 in each first region 803 are aligned in a single row, but the holes 802 in a first region 803 may be aligned in two or more rows as necessary as long as the number of rows is limited to three. Preferably, the first region 803 has a plurality of holes aligned in two or fewer rows in a circumferential direction of the tubular portion, and more preferably in a single row.

### Comparative Example

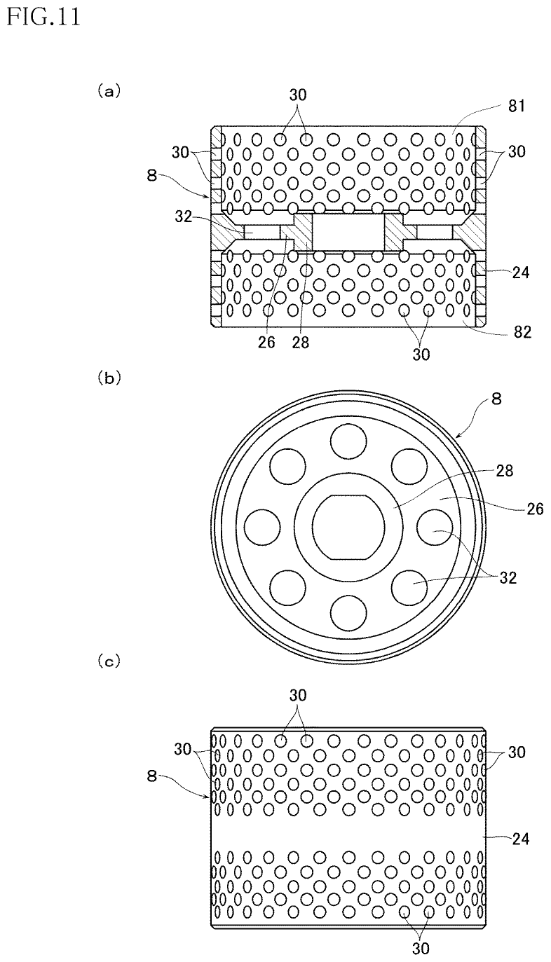

FIG. 11 shows a rotating member 8 of a comparative example. FIG. 11(a) is a sectional view of the rotating member 8, taken along line A-A in FIG. 11(b). FIG. 11(b) is a top view of the rotating member 8. FIG. 11(c) is a side view of the rotating member 8. The rotating member 8 includes a tubular portion 24 of which lateral surface is not divided into the first region and the second region. In other words, the tubular portion 24 has a plurality of holes 30 penetrating in the inward-outward direction in a substantially entire region of the lateral surface of the tubular portion 24 except for the central region in the height direction. In addition, the rotating member 8 includes a horizontal portion 26 having a through-hole 32 providing communication between the upper space 81 and the lower space 82. It should be noted that the comparative example is not prior art for the present invention.

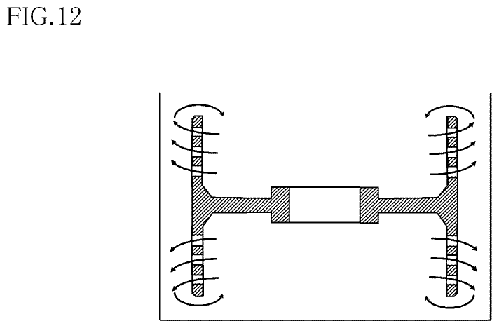

With the rotating member 8, the material to be stirred is forced to move from the inside of the tubular portion 24 to the clearance section generally evenly through the holes 30 that are formed across the substantially entire lateral surface of the tubular portion 24. Unlike the examples of the present invention, the comparative example fails to promote the flow of material from the middle of the tubular portion in the height direction toward the upper and lower end of the tubular portion. As a result, a turbulent flow of material is created in the clearance section as shown in FIG. 12. Consequently, the comparative example fails to ensure the effect of improving the processing efficiency of the material, the effect of reducing the temperature rise of the material, and the effect of achieving sufficient stirring by applying a large shear force to the material.

The stirring device according to the present invention is not limited to the embodiments described above. Various modifications in design may be made freely in the specific structure of each part of the stirring device according to the present invention.

### Reference Numerals

1 stirring device
2 vessel
4 jacket
6 coolant pipe
8, 800, 810, 820 rotating member
10 shaft
12 weir plate
13 outlet pipe
14 upper vessel
16 lid
17, 18 inlet pipe
19, 20 valve
22 inner surface of vessel
24, 801 tubular portion
26, 806 horizontal portion
28 boss
30 small hole
32 through-hole
81, 807 upper space
82, 808 lower space
803 first region
804 second region
805 passage
811 inclined section

1. A stirring device comprising: a vessel; and a rotating member that rotates at high speed at a location slightly inside an inner wall surface of the vessel, the stirring device being configured to stir a material formed into a thin-film shape between the rotating member and the inner wall surface by centrifugal force of the rotating member,
wherein the rotating member includes a tubular portion disposed with a small gap from the inner wall surface of the vessel,
the tubular portion includes a lateral surface provided with:
a first region having a band shape extending in a circumferential direction of the tubular portion, the first region including a plurality of holes penetrating in an inward-outward direction; and
a second region having a band shape extending in the circumferential direction of the tubular portion, the second region including no hole or a plurality of holes penetrating in the inward-outward direction in a manner such that the second region has an aperture ratio smaller than an aperture ratio of the first region,
the first region includes a middle of the tubular portion in a height direction,
the second region ranges from an upper edge of the first region to an upper end of the tubular portion and from a lower edge of the first region to a lower end of the tubular portion, and
the first region has a width Wp from the upper edge to the lower edge, and the tubular portion has a total height H, wherein 0<Wp<0.5H is satisfied.

2. The stirring device according to claim 1, wherein P1 denotes the aperture ratio of the first region, and P2 denotes the aperture ratio of the second region, where 0≤P2/P1<0.5 and P1>0 are satisfied.

3. The stirring device according to claim 1, wherein each of the plurality of holes penetrating in the inward-outward direction in the first region has a larger opening area on inside than on outside.

4. The stirring device according to claim 1, wherein each of the plurality of holes penetrating in the inward-outward direction in the first region has a greater number of openings on inside than on outside.

5. The stirring device according to claim 4, wherein each of the plurality of holes penetrating in the inward-outward direction in the first region has a passage that branches within the tubular portion.

6. The stirring device according to claim 1, wherein the rotating member includes a horizontal portion that is perpendicular to a rotation axis of the rotating member, the horizontal portion dividing an internal space of the tubular portion into an upper space and a lower space.

7. The stirring device according to claim 6, wherein each of the plurality of holes penetrating in the inward-outward direction in the first region has a passage that branches within the tubular portion, and each of the plurality of holes has an inside opening in the upper space and an inside opening in the lower space.

8. The stirring device according to claim 6, wherein the plurality of holes penetrating in the inward-outward direction in the first region include: first holes each having an inside opening in the upper space; and second holes each having an inside opening in the lower space, the first and second holes being arranged alternately in the circumferential direction of the tubular portion.
